(19) United States
(12) Patent Application Publication
(10) Pub. No.: US 2004/0207365 A1
(43) Pub. Date: Oct. 21, 2004

(54) Battery testers

(76) Inventor: Adrian Jones, Cheshire (GB)

Correspondence Address: Clyde L. Smith, Thompson Coburn LLP, One US Bank Plaza, St. Louis, MO, 63101-9928, US

(21) Appl. No.: 10/754,207

(22) Filed: Jan. 9, 2004

Related U.S. Application Data
(63) Continuation of application No. 09/979,585, filed on Jul. 23, 2002, now abandoned.
Application No. 09/979,585 is a 371 of international application No. PCT/GB00/01714, filed on May 5, 2000.

(30) Foreign Application Priority Data
May 10, 1999 (GB) GB9910713.8

(51) Int. Cl. H02J 7/00

(52) U.S. Cl. 320/132

(57) ABSTRACT

A battery tester is disclosed for measuring the fully charged capacity batteries. The battery tester preferably comprises a temperature sensor, a resistor, terminal leads, a back-lit liquid-crystal-display. The battery tester operates by applying the resistance between the terminals of a battery via the terminal leads for a period of preferably a millisecond.

This application is a continuation of copending U.S. patent application Ser. No. 09/979,585 filed on Jul. 23, 2002, which is a national stage filing of PCT Application Number PCT/GB00/01714 filed on May 5, 2000, which claims priority from Great Britain Patent Application No. GB9910713.8 filed on May 10, 1999.

### BACKGROUND OF THE INVENTION

(1) Field of the Invention

This invention pertains to battery testers, and in particular to battery testers for use in testing lead acid batteries.

(2) Background

There is presently no means for assessing how much current is available in a lead acid battery, although its well known that such batteries lose capacity over a period of time and that capacity is temperature dependent. Typically after three years a lead acid battery will only have 90% of its capacity, after four years 60%, and after five years 40%.

Where lead acid batteries are used in critical situations, it would be useful to be able to assess their capacity or amount of energy available. Such a typical critical situation is where a battery is used as a back-up for powering an alarm system.

### SUMMARY OF THE INVENTION

An object of this invention is to provide a tester for use on batteries to assess available energy.

According to this invention there is provided a battery tester for connection to a battery. The battery tester has means for assessing the following values:

a) ambient temperature;

b) D.C. voltage across the battery terminals; and

c) capacity of the battery in amp-hours, wherein the tester is programmed to apply a load to the battery for a short time and to sample the voltage across the battery terminals when the load is applied so as to calculate the capacity therefrom using an algorithm.

The battery tester of the invention preferably has a display for showing the assessed values. The tester is preferably programmed to display the results in sequence for pre-determined time periods. The display preferably is a LCD display that is back-lit.

The battery tester is preferably powered by the battery under test, to which it is connected. Obviously, if the battery under test has no power remaining, the tester will not operate.

The battery tester of the invention is preferably controlled by a microprocessor programmed to convert test values obtained into desirable results for display. The battery tester includes a temperature sensor and is preferably programmed to display the temperature detected in degrees Celsius for a pre-determined period of approximately two seconds. Measurement of ambient temperature is important because the ambient temperature can affect the power output of a battery. Lead acid batteries are usually rated at 25° C., so that testing the ambient temperature allows sensible comparison between a battery's rating and its assessed capacity.

The battery tester is preferably software programmed to a calibrated battery to provide a benchmark. Typically, a calibrated Yuasa brand sealed lead acid 20 amp-hour rated 12 volt battery is used for such purpose.

The battery tester also includes means for measuring the open circuit DC voltage across the battery terminals. The voltage measured is preferably displayed for a pre-determined period of time of approximately two seconds.

Thirdly, the battery tester of the invention has means for assessing the capacity of the battery in amp-hours. The tester applies a load to the battery, typically by means of a resistor, a 1 ohm resistor for example, for a short period of time, e.g. for a millisecond. The voltage across the battery terminals with the load applied is sampled and the capacity calculated therefrom preferably using an algorithm. There may, of course, be other suitable ways of deriving the capacity of a battery from a measured value of the battery, which could be used in the present invention.

In the preferred embodiment of the invention, the battery tester comprises a box containing circuitry that includes a temperature sensor, an LCD display, and leads for connection to a battery. Once the tester is connected to the battery, the programming of the tester causes the tester to produce a display of an ambient temperature reading for about two seconds. Next, an open D.C. voltage across the battery is displayed for about two seconds followed by a display of the capacity of the battery in amp-hours until the tester is disconnected.

It is envisaged that the readings displayed will be marked down on a record card or sheet for the tested battery, so that it can be monitored and so its performance can be checked at a regular intervals, to enable timely replacement of the battery, and to ensure that the battery complies with British Standards, which is particularly important for batteries in critical application situations.

This invention will now be further described, by way of example and with reference to the accompanying drawing.

### BRIEF DESCRIPTION OF THE DRAWINGS

FIG. 1 depicts the preferred embodiment of the invention attached to a battery being tested thereby.

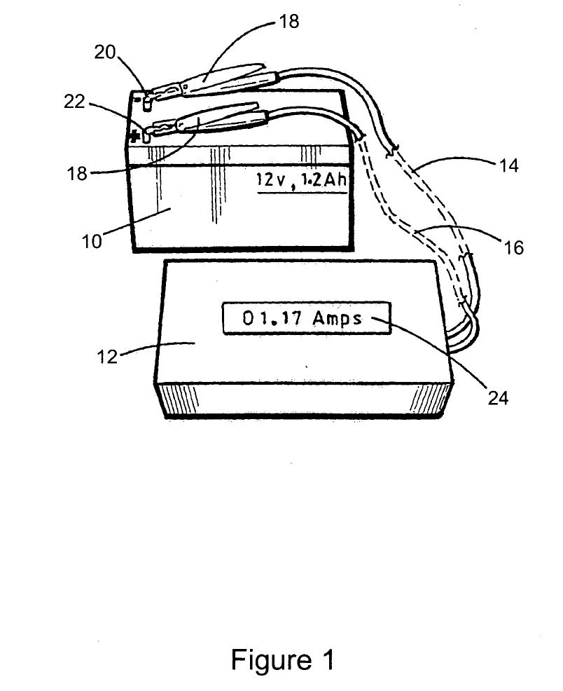

Reference characters in the written specification indicate corresponding items shown in the drawing figure.

### DETAILED DESCRIPTION OF THE PREFERRED EMBODIMENT OF THE INVENTION

Referring to the accompanying drawing, a 12 volt 1.2 Amp battery 10 is shown under test using a battery tester 12 in accordance with the invention. The battery tester has leads 14 and 16 for making an electrical connection between the battery and the tester. The leads 14 and 16 have jaw-type clamps 18 for gripping terminals 20 and 22 of the battery. The tester has an LCD display 24 on which are displayed in sequence ambient temperature, open circuit DC voltage across the battery, and the battery capacity in amp-hours.

The circuitry of the tester comprises a PCB containing:

a) a 5 volt regulated power supply;

b) an analogue to digital converter;

c) an 8/16 bit microprocessor;

d) a battery monitor device which incorporates a temperature sensor;

e) a 1 ohm wire-wound electrical resistor; and

f) a back-lit LCD display.

Power for the tester is provided by the battery under test.

When powered up by the battery under test, the programmed microprocessor sends a command instruction to the battery monitor device to take a temperature reading, which is analyzed and displayed in degrees Celsius on the LCD for approximately two seconds.

For some markets, the battery tester may be arranged to show the temperature in degrees Fahrenheit. Alternatively, the battery tester may have means for selecting the scale of the temperature measurement, e.g. between degrees Celsius and degrees Fahrenheit.

Once completed, a second command instruction causes the battery monitor to take a voltage reading across the terminals of the battery, which is again displayed for about two seconds. Finally, a third command instruction asks the battery monitor to place a momentary 1 ohm load across the battery under test whilst measuring the voltage. This voltage sample is analyzed in real time and converted into a capacity reading, which is displayed on the LCD and maintained until the battery tester is disconnected from the battery.

The various displayed readings can be recorded on a record sheet or on any other suitable recording medium for regular monitoring of the battery under test.

While the present invention has been described in reference to a specific embodiment, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims.

What is claimed is:

1. A method of testing the fully charged capacity of a battery comprising:
providing a battery tester, the battery tester comprising a temperature sensor, a display device, and a pair of leads;
providing a battery, the battery having at least two terminals;
attaching one of the pair of leads of the battery tester to one of the terminals of the battery and the other of the pair of leads of the battery tester to the other of the terminals of the battery;
utilizing the temperature sensor of the battery tester to assess an approximate temperature of the battery;
utilizing the battery tester to assess a voltage between the terminals of the battery when the leads of the battery tester are attached to the terminals of the battery as recited;
utilizing the battery tester to apply a momentary load to the battery when the leads of the battery tester are attached to the terminals of the battery as recited; and
utilizing the battery tester to sample a voltage response across the terminals of the battery when the momentary load is applied to the battery as recited so as to access a fully charged capacity of the battery.

2. A method in accordance with claim 1 wherein power for performing the steps of utilizing the temperature sensor of the battery tester, utilizing the battery tester to assess a voltage between the terminals of the battery, utilizing the battery tester to apply a momentary load to the battery, and utilizing the battery tester to sample a voltage response across the terminals of the battery, is provided by the battery.

3. A method in accordance with claim 1 further comprising a step of displaying the approximate temperature of the battery, the voltage between the terminals of the battery, and the fully charged capacity of the battery.

4. A method in accordance with claim 3 wherein the step of providing the battery tester occurs in a manner such that the battery tester comprises an LCD display, and wherein the step of displaying comprises the use of the LCD display.

5. A method in accordance with claim 4 wherein the step of providing the battery tester occurs in a manner such that the LCD display is back-lit, and wherein the step of displaying comprises back-lighting the LCD display.

6. A method in accordance with claim 3 wherein the step of displaying occurs in a manner such that each of the approximate temperature of the battery, the voltage between the terminals of the battery, and the fully charged capacity of the battery, are displayed sequentially for predetermined time periods.

7. A method in accordance with claim 6, wherein the step of displaying occurs in a manner such that the predetermined time period for display of the approximate battery temperature is two seconds.

8. A method in accordance with claim 6 wherein the step of displaying occurs in a manner such that the predetermined time period for display of the voltage between the terminals of the battery is two seconds.

9. A method in accordance with claim 1 wherein the step of utilizing the battery tester to apply a momentary load to the battery comprises applying the load for no more than one second.

10. A method in accordance with claim 9 wherein the step of utilizing the battery tester to apply a momentary load to the battery comprises applying the load for no more than approximately one millisecond.

11. A method in accordance with claim 1, wherein the step of utilizing the battery tester to apply a momentary load to the battery comprises applying a resistance of approximately one ohm between the terminals of the battery.

12. A method in accordance with claim 11 wherein the step of utilizing the battery tester to apply a momentary load to the battery comprises applying the load for no more than approximately one millisecond.

13. A battery tester device comprising, a pair of leads, a temperature sensor, a display device, and a resistor, the battery tester device being adapted and configured to operatively connect the leads to each other via the resistor for a period of approximately one-millisecond.

14. A battery tester device in accordance with claim 13 wherein the resistor has a resistance of approximately one ohm.

15. A battery tester device in accordance with claim 13 wherein the display device is a back-lit LCD.
